(19) United States
(12) Patent Application Publication
(10) Pub. No.: US 2026/0152428 A1
(43) Pub. Date: Jun. 4, 2026

(54) METHODS FOR SEPARATING A GLASS RIBBON AND SIMULTANEOUSLY SHAPE-FORMING A SEPARATED EDGE THEREOF

(71) Applicant: CORNING INCORPORATED, CORNING, NY (US)

(72) Inventors: Anatoli Anatolyevich Abramov, Painted Post, NY (US); Christopher Charles Chilson, Wellsboro, PA (US)

(21) Appl. No.: 19/390,852

(22) Filed: Nov. 17, 2025

Related U.S. Application Data
(60) Provisional application No. 63/726,541, filed on Nov. 30, 2024.

(51) Int. Cl. C03B 33/08; C03B 33/023

(52) U.S. Cl. CPC C03B 33/082; C03B 33/0235

(57) ABSTRACT

A method for separating a glass ribbon comprises moving the ribbon at a ribbon velocity vector in a conveyance direction. The method further comprises exposing a path on the ribbon to a laser beam to heat the ribbon along the path. The method further comprises moving the laser beam at a spot velocity vector in the conveyance direction that is equal to the ribbon velocity vector. The path continues to be exposed to the laser beam while the ribbon moves at the ribbon velocity vector. The method further comprises melting the ribbon along the path while the path is rapidly heated during the exposing and the moving. In response to the melting, a glass sheet is separated from the ribbon along the path and rounded, separated edges are simultaneously formed adjacent the path on the glass sheet and the ribbon.

### CROSS-REFERENCE TO RELATED APPLICATIONS

This application claims the benefit of priority under 35 U.S.C. § 119 of U.S. Provisional Application No. 63/726,541 filed Nov. 30, 2024, the content of which is incorporated herein by reference in its entirety.

### FIELD

The present disclosure relates generally to methods for separating a glass ribbon and, more particularly, to methods for separating a glass ribbon near the draw by rapidly melting the glass ribbon along a widthwise separation path that translates with the glass ribbon during a continuous hot forming process.

### BACKGROUND

It is known to separate a glass ribbon to achieve a glass sheet with the desired dimensions. Conventional separation techniques achieve separation while the glass ribbon is moving, thereby avoiding uninterrupted traversing of the glass ribbon along a travel direction while separating the glass sheet from the glass ribbon. These conventional separation techniques can include laser-based heating techniques that perform separation at processing temperatures of the glass ribbon that are below the glass strain point, such as temperatures equal to or less than 400° C. However, such convention separation techniques, including both mechanical-based and laser-based techniques, typically leave a characteristic (sharp) edge that requires additional finishing procedures to provide the desired round edge. Finishing of the sheet edges is a complicated and lengthy process, which implies significant operational and capital equipment cost. Moreover, in many applications, these finished edges are only temporary since the as-shipped glass sheets are often cut to smaller sizes and the as-shipped finished edge is removed and/or discarded during such resizing. Consequently, it would be advantageous to provide one or more glass ribbon separation methods that solve these and other problems.

### SUMMARY

The following summary is a brief description of certain aspects of the present disclosure. The summary should not be considered as limiting of the breadth, scope, or applicability of the present disclosure.

According to aspect (1), a method for separating a glass ribbon is provided. The method comprises: (a) moving the glass ribbon at a glass ribbon velocity including a glass ribbon velocity vector in a conveyance direction of the moving glass ribbon; (b) exposing a separation path on the glass ribbon to at least one laser beam spot to rapidly heat the glass ribbon along the separation path, the separation path extending in a direction transverse to the conveyance direction to opposed lateral edges of the glass ribbon; (c) moving the laser beam spot at a laser beam spot velocity including a laser beam spot velocity vector in the conveyance direction that is equal to the glass ribbon velocity vector, wherein the separation path continues to be exposed to the laser beam spot to continue rapidly heating the glass ribbon along the separation path while the glass ribbon moves at the glass ribbon velocity; and (d) melting the glass ribbon along the separation path while the separation path is rapidly heated during steps (b) and (c), wherein, in response to the melting, a glass ribbon portion is separated from the glass ribbon along the separation path and rounded, separated edges are simultaneously formed adjacent the separation path on both the glass ribbon portion and the glass ribbon.

### BRIEF DESCRIPTION OF THE DRAWINGS

Various exemplary embodiments of the present disclosure are described in detail below with reference to the following drawings. The drawings are provided for purposes of illustration only and merely depict exemplary embodiments of the present disclosure to facilitate the understanding of the present disclosure. Therefore, the drawings should not be considered as limiting of the breadth, scope, or applicability of the present disclosure. It should be noted that for clarity and ease of illustration these drawings are not necessarily drawn to scale.

FIG. 1 is a schematic view of a fusion down-draw apparatus configured to draw a glass ribbon and an exemplary glass ribbon separating apparatus;

FIG. 2 is a cross-sectional schematic view of an exemplary glass separation apparatus along line 2-2 of FIG. 1, wherein the separation path on the glass ribbon is positioned within the depth of focus of the laser beam;

FIG. 3 is a side view of the glass ribbon of FIG. 2, illustrating a varying power density along the separation path of the glass ribbon;

FIGS. 4-7 are sequential perspective schematic views of a glass separation apparatus exposing a separation path on the glass ribbon while tracking a movement of the glass ribbon;

FIG. 8 is a cross sectional schematic view of a glass separation apparatus along line 2-2 of FIG. 1, wherein a laser beam emitted from the apparatus is exposing an upstream end of a separation path on the glass ribbon;

FIG. 9 is a perspective schematic view of the glass separation apparatus of FIG. 8 exposing a separation path on the glass ribbon at an upstream location;

FIG. 10 is a side view of a glass separation apparatus moved by an embodiment of a tracking feature configured to track a movement of the glass ribbon while exposing a separation path on the glass ribbon;

FIG. 11 is a side view of a glass separation apparatus moved by another embodiment of a tracking feature configured to track a movement of the glass ribbon while exposing a separation path on the glass ribbon;

FIG. 12 is a thermal image of a sample glass ribbon showing a temperature distribution of the sample glass ribbon in the annealing zone of a glass manufacturing apparatus;

FIG. 13 illustrates the principle of glass ribbon cutting when a Gaussian profile or a flat-top beam profile is used to irradiate the glass ribbon;

FIG. 14 depicts superposition of two Gaussian beams to form a nearly flat-top profile in the central portion of the resultant beam;

FIG. 15 depicts superposition of two Gaussian beams to form a donut-shape beam;

FIG. 16 is a thermal image of a sample glass ribbon laser-heated via a donut-shape beam profile similar to that depicted in FIG. 15;

FIG. 17 illustrates laser heating of a sample glass ribbon by a single laser beam in the annealing zone;

FIG. 18 is a thermal image of the sample glass ribbon of FIG. 17;

FIG. 19 illustrates a sample glass ribbon at the moment of ribbon separation in the annealing zone;

FIG. 20 is a thermal image of the sample glass ribbon of FIG. 19;

FIGS. 21 and 22 show examples of a shape of the separated edges after separation from sample glass ribbons of different thicknesses; and

FIG. 23 show an example of the shape of the rounded corner that is formed at the intersection of the separated edge and the lateral edge of a sample glass ribbon with a thickness of about 75 μm.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles disclosed herein as would normally occur to one skilled in the art to which this disclosure pertains.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range was explicitly recited. As an illustration, a numerical range of “about 1 to about 5” should be interpreted to include not only the explicitly recited values of about 1 to about 5, but also to include individual values and sub-ranges within the indicated range. Thus, included in this numerical range are individual values such as 2, 3, and 4, the sub ranges such as from 1-3, from 2-4, from 3-5, etc., as well as 1, 2, 3, 4, and 5 individually. The same principle applies to ranges reciting only one numerical value as a minimum or maximum. Furthermore, such an interpretation should apply regardless of the breadth of the range or the characteristics being described by the range.

The terms “substantial,” “substantially,” and variations thereof as used herein, unless defined elsewhere in association with specific terms or phrases, are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

Directional terms as used herein—for example up, down, right, left, front, back, top, bottom, above, below, and the like—are made only with reference to the figures as drawn and are not intended to imply absolute orientation.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

It is to be understood that specific embodiments disclosed herein are intended to be exemplary and therefore non-limiting. As such, the present disclosure relates to methods and apparatus for separating a glass ribbon. In embodiments, the glass ribbon can include a glass ribbon formed from any glass forming process or glass manufacturing process. The glass ribbon can be provided directly from a glass forming apparatus or glass manufacturing apparatus, can be provided as a spool of glass ribbon that can be rolled or coiled onto a core, or can be provided as a freestanding glass ribbon. In other embodiments, the glass ribbon can include a glass sheet formed by any glass forming process or glass manufacturing process. The glass sheet can be provided as a glass sheet separated from a glass ribbon, as a glass sheet separated from another glass sheet, as one or more glass sheets provided as a spool of one or more glass sheets rolled or coiled onto a core, as a stack of glass sheets, or as a freestanding glass sheet.

Glass sheets separated from the glass ribbon can be suitable for further processing into a desired display application. The glass sheets can be used in a wide range of display applications, including liquid crystal displays (LCDs), electrophoretic displays (EPD), organic light emitting diode displays (OLEDs), plasma display panels (PDPs), or the like. Glass sheets may need to be transported from one location to another. The glass sheets may be transported with a conventional support frame designed to secure a stack of glass sheets in place. Moreover, interleaf material can be placed between each sheet of glass to help prevent contact and therefore preserve the pristine surfaces of the glass sheets.

In embodiments, methods of separating a glass ribbon can be used in conjunction with a glass manufacturing apparatus configured to fabricate the glass ribbon although other glass processing apparatus can be provided in further embodiments. In embodiments, the glass manufacturing apparatus can comprise a slot draw apparatus, float bath apparatus, down-draw apparatus, up-draw apparatus, press-rolling apparatus, or other glass ribbon manufacturing apparatus.

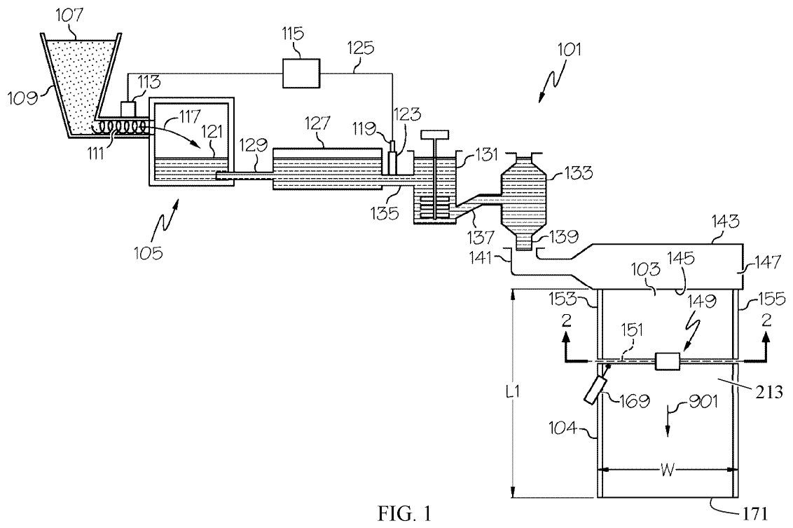

By way of example, FIG. 1 schematically illustrates an apparatus for processing a quantity of glass melt comprising a fusion down-draw apparatus 101 for fusion drawing a glass ribbon 103 for subsequent separation, for example, separation into another glass ribbon such as the illustrated glass sheet 104. The fusion down-draw apparatus 101 can include a melting vessel 105 that receives batch material 107 from a storage bin 109. The batch material 107 can be introduced by a batch delivery device 111 powered by a motor 113. An optional controller 115 can be used to activate the motor 113 to introduce a desired amount of batch material 107 into the melting vessel 105, as indicated by arrow 117. A glass melt probe 119 can be used to measure a glass melt 121 level within a standpipe 123 and communicate the measured information to the controller 115 by way of a communication line 125.

The fusion down-draw apparatus 101 can also include a first conditioning station such as a fining vessel 127 located downstream from the melting vessel 105 and coupled to the melting vessel 105 by way of a first connecting conduit 129. In embodiments, the glass melt can be gravity fed from the melting vessel 105 to the fining vessel 127 by way of the first connecting conduit 129. For instance, gravity can act to drive the glass melt to pass through an interior pathway of the first connecting conduit 129 from the melting vessel 105 to the fining vessel 127. Within the fining vessel 127, bubbles can be removed from the glass melt by various techniques.

The fusion draw apparatus 101 can further include a second conditioning station such as a glass melt mixing vessel 131 that can be located downstream from the fining vessel 127. The glass melt mixing vessel 131 can be used to provide a homogenous glass melt composition, thereby reducing or eliminating cords of inhomogeneity that can otherwise exist within the fined glass melt exiting the fining vessel. As shown, the fining vessel 127 can be coupled to the glass melt mixing vessel 131 by way of a second connecting conduit 135. In embodiments, the glass melt can be gravity fed from the fining vessel 127 to the glass melt mixing vessel 131 by way of the second connecting conduit 135. For instance, gravity can act to drive the glass melt to pass through an interior pathway of the second connecting conduit 135 from the fining vessel 127 to the glass melt mixing vessel 131.

The fusion draw apparatus 101 can further include another conditioning station such as a delivery vessel 133 that can be located downstream from the glass melt mixing vessel 131. The delivery vessel 133 can condition the glass to be fed into a forming device. For instance, the delivery vessel 133 can act as an accumulator and/or flow controller to adjust and provide a consistent flow of glass melt to the forming vessel. As shown, the glass melt mixing vessel 131 can be coupled to the delivery vessel 133 by way of a third connecting conduit 137. In embodiments, the glass melt can be gravity fed from the glass melt mixing vessel 131 to the delivery vessel 133 by way of the third connecting conduit 137. For instance, gravity can act to drive the glass melt to pass through an interior pathway of the third connecting conduit 137 from the glass melt mixing vessel 131 to the delivery vessel 133.

The fusion draw apparatus 101 can further include a downcomer 139 positioned to deliver the glass melt 121 from the delivery vessel 133 to an inlet 141 of a forming vessel 143. The glass ribbon 103 can then be fusion drawn off a root 145 of a forming wedge 147 and subsequently separated into a glass ribbon, such as another glass ribbon or the illustrated glass sheet 104, by a glass separation apparatus 149.

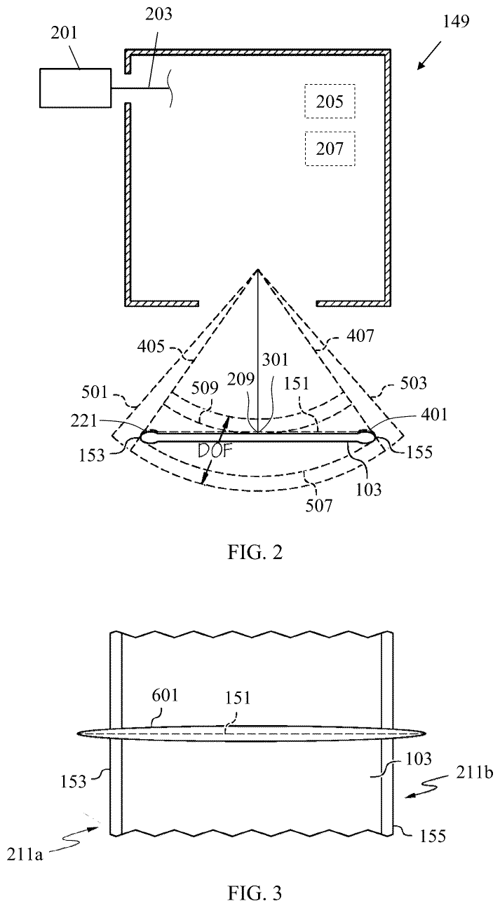

FIG. 1 is a general schematic of the glass separation apparatus 149 implemented on the fusion draw apparatus 101 whereas FIGS. 2, 4-7, 10, and 11 schematically depict further aspects of the glass separation apparatus 149 to facilitate a description of the methods for separating the glass ribbon 103 and simultaneously shape-forming separated edges thereof. As shown in FIG. 1, the glass separation apparatus 149 can divide the glass sheet 104 from the glass ribbon 103 along a separation path 151 that extends linearly (as represented by the dashed line associated with reference numeral 151) in a direction (or axis) that is transverse to the conveyance direction such as the draw direction 901. As illustrated in FIG. 1, in any of the embodiments of the disclosure, the direction transverse to the conveyance direction 901 can include the direction being perpendicular to the conveyance direction 901 or at another angle relative to the conveyance direction. In embodiments, the direction of the separation path 151 extends along a width W of the glass ribbon 103 between a first outer (lateral) edge 153 and a second outer (lateral) edge 155 of the glass ribbon 103.

As illustrated in FIG. 1, in embodiments, the conveyance direction 901 of the glass ribbon 103 can include the draw direction of the glass ribbon. In the illustrated embodiment, the conveyance direction 901 can be the fusion draw direction of the glass ribbon 103 being fusion down-drawn from the forming vessel 143. Alternatively, if the glass ribbon is being unwound from a spool of glass ribbon, the conveyance direction can be considered the direction along which the glass ribbon is being drawn from the spool. Still further, if the glass ribbon (e.g., glass ribbon, glass sheet, etc.) is being traversed along a travel path, the conveyance direction can be considered the direction that the glass ribbon travels along the travel path.

In embodiments, such as shown in FIG. 1, a length of the glass ribbon 103 can be considered the overall length L1 of the glass ribbon 103 extending from the root 145 of the forming wedge 147 to an outer end 171 (e.g., lower end) of the glass ribbon 103. In further embodiments, the length of the glass ribbon 103 can be considered a portion of the overall length L1 of the glass ribbon. For example, the length of the glass ribbon 103 can be considered a dimension of the glass ribbon along a direction perpendicular to the width W of the glass ribbon 103. Additionally, or alternatively, the length of the glass ribbon 103 can be considered a dimension of the glass ribbon along the draw direction 901 of the glass ribbon 103.

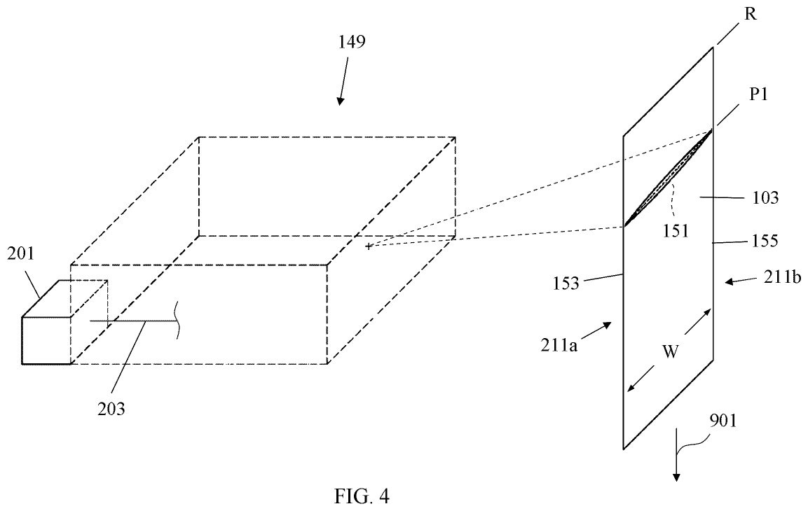

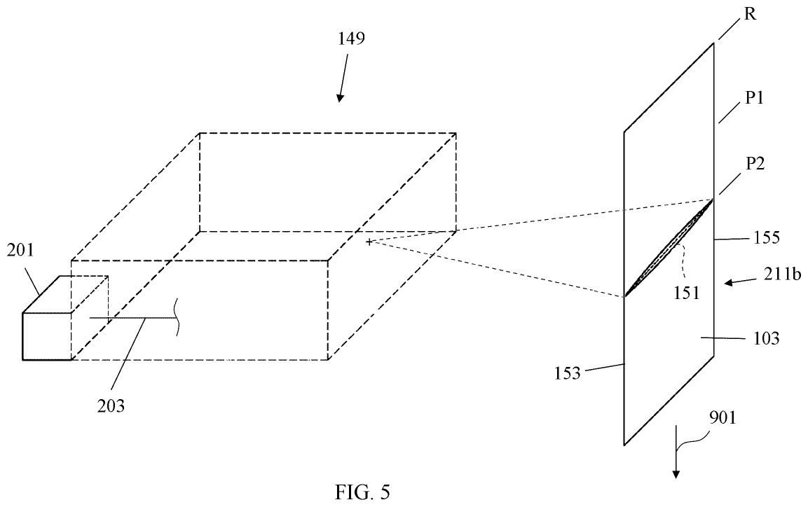

Referring now to FIGS. 2-4, further aspects of the glass separation apparatus 149 are shown to facilitate a description of the methods for separating the glass ribbon 103 and simultaneously shape-forming separated edges thereof. FIG. 2 is a cross-sectional view of an exemplary glass separation apparatus 149 along line 2-2 of FIG. 1, illustrating use of laser radiation to expose the separation path 151 on the glass ribbon 103. FIG. 3 is a side view of the glass ribbon 103 of FIG. 2, illustrating a varying power density of the laser radiation along the separation path 151. FIG. 4 is a perspective schematic view of the glass separation apparatus 149 exposing the separation path 151 at a first position P1 (e.g., an upstream position). As will be described later in this disclosure, the first position P1 can be indicated relative to a fixed reference point R, such as the root 145 of the forming vessel 143 of the fusion down-draw apparatus 101, since the glass ribbon 103 can be moving in the conveyance direction 901 during exposure of the separation path 151.

As shown in FIGS. 2-4, the glass separation apparatus 149 can include a laser beam generator 201 configured to emit a laser beam 203. In embodiments, the laser beam generator 201 can be a carbon monoxide (CO) laser that emits a CO laser beam at wavelengths from about 5 μm to about 6 μm or a carbon dioxide (CO₂) laser that emits a CO₂ laser beam at wavelengths from about 9 μm to about 11 μm. The beam generator 201 can be based on other lasers in other embodiments. The glass separation apparatus 149 can comprise optical components, such as reflectors 205 (e.g., stationary, articulating, spinning, etc.), lenses 207 (spherical, cylindrical, aspheric, etc.), and other optical elements (beam splitters, beam scanners, etc.), configured to shape the laser radiation and direct the (shaped) laser radiation towards the glass ribbon 103 within a specified region to define the separation path 151 on the glass ribbon 151. In embodiments, for example, the optical components can be configured to direct the laser radiation between extreme positions from the first outer edge 153 to the second outer edge 155 of the glass ribbon 103, such as between first and second outer positions 405, 407 shown in FIG. 2. In embodiments, the optical components can be configured to direct the laser radiation between positions that are off of the glass ribbon 103, such as between outer positions 501, 503 shown in FIG. 2.

As described later in the disclosure, the laser beam 203 can rapidly heat the glass ribbon 103 along the separation path 151. Throughout the drawings, the separation path 151 is schematically shown as a broken (dashed) line with the understanding that the actual separation path is coincident with the glass ribbon such as the edge portions and/or major surfaces of the glass ribbon. As shown, the separation path 151 can extend along the outer edge portions 211a, 211b and a first major surface 213 of the glass ribbon 103 facing the glass separation apparatus 149 from the first outer edge 153 to the second outer edge 155, although the separation path can extend along the opposite major surface of the glass ribbon or at an intermediate location between the two major surfaces of the glass ribbon. Indeed, as shown, the separation path 151 can extend coincident with the outer surfaces of the outer edge portions 211a, 211b and also extend coincident with the first major surface 213 of the glass ribbon 103. Furthermore, as shown, the first outer edge portion 211a can include the first outer edge 153 and the second outer edge portion 211b can include the second outer edge 155 wherein the separation path 151 can extend across a substantial portion or the entire width W of the glass ribbon.

The glass separation apparatus 149 (e.g., in cooperation with the laser beam generator 201, the laser beam 203, and the optical components) is configured to provide a laser beam spot 209 on the first major surface 213 (FIG. 1) of the glass ribbon 103 or glass sheet 104. As used herein, a laser beam spot 209 is considered the area of the surface of the glass ribbon exposed to the laser beam 203 where the laser beam 203 intersects the surface of the glass ribbon. In embodiments, the laser beam spot 209 can comprise a circular or rectangular laser beam spot or an oblong laser beam spot that is significantly less than the overall length of the separation path 151. In such embodiments, the laser beam spot 209 can be a moving spot that is swept repeatedly across the surface 213 of the glass ribbon 103 over the entire length of the separation path 151 (e.g., between first and second outer positions 405, 407) or even greater than the entire length of the separation path (e.g., between outer positions 501, 503). In embodiments, the laser beam spot can be stationary spot and comprises one (e.g., exactly one) elongated laser beam spot that spans the entire length of the separation path 151 (e.g., between first and second outer positions 405, 407) or even greater than the entire length of the separation path (e.g., between outer positions 501, 503).

In embodiments, the laser beam spot 209 can comprise a circular laser beam spot, although elliptical or other spot shapes can be provided in further embodiments. A minimum diameter of the circular laser beam spot at the focused waist can be from about 1 mm to about 2 mm, when determined as 1/e² of the intensity profile of the circular laser beam spot, although other dimensions can be provided in further embodiments. Likewise, the maximum length of an elliptical or other spot shape can be from about 1 mm to about 3 mm, although other dimensions can be provided in further embodiments. For example, when utilizing a stationary laser beam, the laser beam spot shape can be substantially elongated and have a length of tens of centimeters, for example, in excess of 1 meter in length. One or a plurality of stationary laser beam spots can be used to expose the separation path 151.

In embodiments, the laser beam spot 209 is depicted as a moving spot that is swept across a substantial portion of the glass ribbon, such as the entire dimension of the glass ribbon. or a stationary spot that is stretched or elongated to extend across a substantial portion, such as the entire dimension of the glass ribbon. In such embodiments, the laser beam spot 209 can also be swept off the glass ribbon or be stretched or elongated to extend off the glass ribbon. As such, the separation path 151 can likewise extend across a substantial portion of the glass ribbon, such as the entire dimension of the glass ribbon. For instance, as illustrated, the laser beam spot 209 passes or extends along the entire width W of the glass ribbon 103 from the first outer edge 153 to the second outer edge 155 such that the separation path 151 extends the entire width W of the glass ribbon 103. In embodiments, the separation path 151, 163 can be from about 50 mm to about 5000 mm, such as from about 50 mm to about 1000 mm, although the laser beam spot 209 can be swept or stretched along longer or shorter paths in further embodiments.

In embodiments, the glass separation apparatus 149 is configured with laser parameters, such as power, wavelength, operating mode (e.g., pulsed or continuous wave), exposure time, exposure area, and other parameters, selected to enable the laser radiation to quickly and uniformly (e.g., substantially uniformly) heat the glass ribbon 103 along the narrow separation path 151 from a baseline temperature T1 (e.g., a first temperature) of the glass of the glass ribbon 103 to a melting temperature T2 (e.g., a second temperature) of the glass. Due to high absorption of laser radiation in the glass of the glass ribbon, as discussed later in this disclosure, the laser radiation is first absorbed in a skin layer of the glass ribbon 103 (e.g., from about 10 μm to about 20 μm from the surface) and then transferred through the glass thickness due to thermal conductivity. As such, excessive laser energy can cause damage to the skin layer via ablation and/or evaporation of the glass therein. Therefore, in embodiments, the laser beam 203 is configured to quickly and uniformly (e.g., substantially uniformly) heat the skin layer and through the glass thickness along the separation path 151 on the glass ribbon 103 up to the melting temperature T2 of the glass without damaging the glass ribbon 103.

As used herein, heating the separation path on the glass ribbon up to the melting temperature without damaging the glass ribbon is intended to mean heating the separation path without damaging the glass ribbon in a manner that would otherwise result in separation of the glass ribbon prior to the intended melting-based separation discussed later in this disclosure. Examples of heating a separation path without damaging the glass ribbon can include heating without ablating the glass ribbon, heating without creating a full-body crack in the glass ribbon, and heating without scoring the glass ribbon. The laser beam 203 can avoid damaging the glass ribbon to allow uniform, localized heating of the glass ribbon 103 along the separation path 151 without separating the glass ribbon prior to the intended melting-based separation discussed later in this disclosure.

An exemplary method for separating the glass ribbon 103 and simultaneously shape-forming separated edges will now be described. The method is described with reference to the fusion down-draw apparatus 101 and the glass separation apparatus 149 schematically depicted in FIG. 1. The method is also described with reference to various aspects of the glass separation apparatus 149 schematically depicted in FIGS. 2-14. In embodiments, the method comprises, in a step (a), moving the glass ribbon 103 at a glass ribbon velocity including a glass ribbon velocity vector in a direction of the length of the glass ribbon 103, such as the conveyance direction 901 of the moving glass ribbon 103. In embodiments, the glass ribbon 103 comprises the length L1 and the width W extending between the first outer edge 153 and the second outer edge 155 of the glass ribbon 130 and the conveyance direction 901 is the direction of the length L1 of the glass ribbon 103. In embodiments, the glass ribbon is drawn from the forming body or forming vessel 143, and the conveyance direction 901 is the draw direction of the glass ribbon 103.

In embodiments, the glass ribbon 103 can be moved, such as unwound, from a spool of glass ribbon previously produced wherein the unwound portion of the glass ribbon travels along the length of the glass ribbon. In such embodiments, the spool of glass ribbon can be unwound wherein the glass sheet can be separated from the glass ribbon without interruption of the process of unwinding the glass ribbon from the spool of glass ribbon. Furthermore, the illustrated embodiment of the glass ribbon 103 is shown being moved in a conveyance direction 901 (e.g., draw direction) such as in a direction of gravity wherein the draw direction is the same direction as the direction of the length of the glass ribbon and the conveyance direction of the glass ribbon. In embodiments, the glass ribbon can be moved at an angle or even along a direction perpendicular to gravity. For example, the glass ribbon 103 can be traveling horizontally along the length of the glass ribbon, such as on air bars or fluid, during transport and/or during processing of the glass ribbon. In such embodiments, the glass sheet 104 can be separated from the glass ribbon 103 as the glass ribbon travels in a lateral (e.g., horizontal) conveyance direction.

The method further comprises, in a step (b), exposing the separation path 151 on the glass ribbon 103 to at least one laser beam spot 209 to rapidly heat the glass ribbon 103 along the separation path 151. As described hereinabove, the laser beam 203 via the at least one laser spot 209 is configured to quickly and uniformly (e.g., substantially uniformly) heat the skin layer and through the glass thickness along the separation path 151 on the glass ribbon 103 up to the melting temperature T2 of the glass without damaging the glass ribbon 103. In embodiments, the separation path 151 is considered the path on the first major surface 213 where separation will occur, for example, via the melting-based separation that occurs along the separation path and through the entire thickness of the glass ribbon from the first major surface of the glass ribbon to the second major surface of the glass ribbon in response to the melting, as discussed later in this disclosure. The separation path 151 can extend in a direction of the width W of the glass ribbon. For example, the separation path can optionally be perpendicular to the length L1 such that the resultant directional vector of the separation path 151 is identical to the resultant directional vector of the width W of the glass ribbon. In embodiments, the separation path extends in the direction transverse to the conveyance direction to and between the opposed lateral edges (e.g., the first outer edge 153 and the second outer edge 153) of the glass ribbon 103.

In embodiments, the step (b) of exposing the separation path 151 on the glass ribbon 103 to the at least one laser beam spot 209 comprises positioning the separation path 151 within an annealing zone of the glass ribbon 103 along which the baseline temperature T1 of the glass ribbon 103 is within an annealing range of the glass (e.g., a glass composition) of the glass ribbon 103. The annealing range represents a range of temperatures at which internal stresses within the glass can be relieved without causing significant deformation or crystallization. The lower end of the annealing range is the temperature at which the glass has sufficient viscosity to prevent deformation but is still soft enough to allow for stress relaxation. The upper end of the annealing range is the temperature above which the glass may become too soft and start to deform under its own weight. It should be appreciated that the exact annealing range will depend on the specific chemical composition of the glass.

Those skilled in the art can determine the appropriate annealing range through customary experimental testing and material science principles. The annealing range for a given glass (e.g., glass composition) is less than the softening temperature and the melting temperature. The annealing range for a given glass is greater than the strain point (temperature), such as typically about 50° C. to 100° C. greater than the strain point. By exposing the separation path 151 on the glass ribbon 103 to the at least one laser beam spot 209 while the background or baseline temperature T1 of the glass ribbon 103 is within the annealing range, residual stress that can be caused by the laser heating of the glass, particularly up to the melting temperature T2 of the glass ribbon 103, can be minimized or avoided.

In embodiments, the wavelength of the at least one laser beam spot 209 is within the infrared portion of the electromagnetic spectrum. In embodiments, the wavelength of the at least one laser beam spot 209 is within a range at which glasses of different compositions have high absorption so as to facilitate rapid laser heating of the glass ribbon 103. In embodiments, the wavelength of the at least one laser beam spot 209 is in a range of from about 2 μm to about 20 μm, such as from about 3 μm to about 19 μm, from about 4 μm to about 18 μm, from about 5 μm to about 17 μm, from about 6 μm to about 16 μm, from about 7 μm to about 15, from about 8 μm to about 14 μm from about 9 μm to about 13 μm, from about 2 μm to about 10 μm, from about 3 μm to about 9 μm from about 4 μm to about 8 μm, from about 5 μm to about 7 μm, from about 10 μm to about 20 μm, from about 11 μm to about 19 μm, from about 12 μm to about 18 μm, from about 13 μm to about 17 μm, from about 14 μm to about 16 μm, and also comprising all sub-ranges and sub-values between these range endpoints.

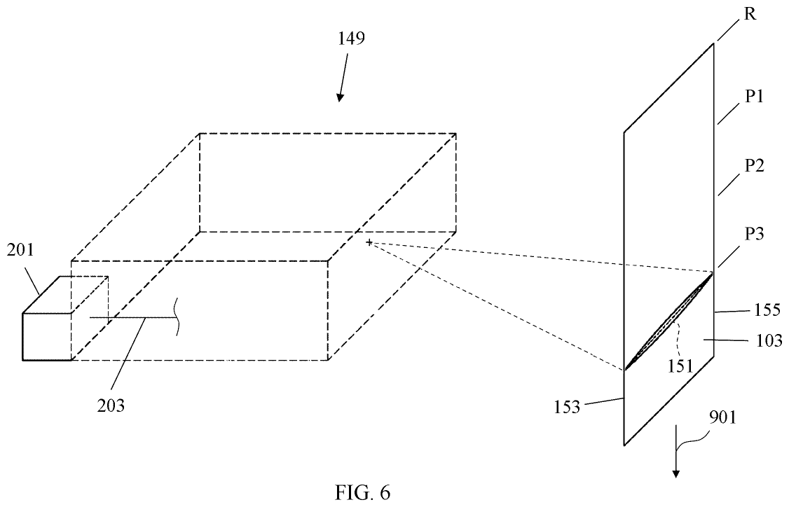

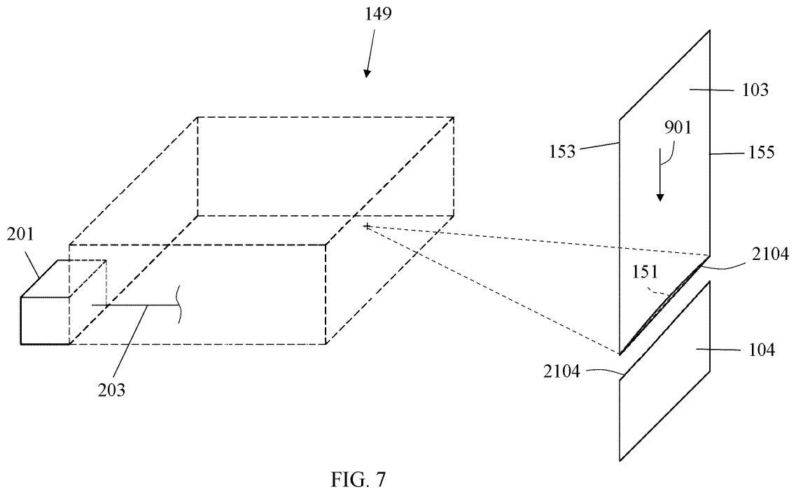

The method will now be described with reference to FIGS. 2-9. These figures depict various implementations of the glass separation apparatus that can be used to carry out aspects of step (b) of the method, which has been described above to some extent, and to carry out aspects of steps (c) through (d) of the method, which will be described later in this disclosure. FIGS. 2-7 schematically depict general implementations of the glass separation apparatus whereas FIGS. 8 and 9 schematically depict a specific implementation of the glass separation apparatus. In the following description of the method, it should be appreciated that any implementation disclosed hereinafter is intended to be exemplary and therefore non-limiting.

FIGS. 2, 3, 8, and 9 schematically depict implementations of the glass separation apparatus 149, 849 that can be used to carry out aspects of step (b) of the method disclosed herein. As shown in FIGS. 8 and 9, the glass separation apparatus 149, 849 can further include an optional series of reflectors 205a, 205b, 205c, 205d and one or more optical lenses 207 configured to provide the laser beam spot 209 on the outer edge portion 211a, 211b and/or the first major surface 213 of the glass ribbon 103 or the glass sheet 104.

In embodiments, the glass separation apparatus 149, 849 can include a first reflector, such as the illustrated polygonal reflector 215. The first reflector can include a first reflective surface. For instance, as shown in FIGS. 8 and 9, the illustrated polygonal reflector 215 can include an octagonal reflector wherein the first reflective surface can comprise eight reflective surface segments 219a-h that can be integral with one another or provided as separate segments that are mounted in close proximity relative to one another. Furthermore, although an octagonal reflector can be used, other reflectors with more or less reflective surface segments can be used in accordance with aspects of the disclosure. The first reflective surface, or any reflective surface of the first reflector, or the reflective surface of any reflector of the disclosure, can comprise a surface of a mirror that reflects light from the reflective surface of the mirror, a reflective surface of polished metal or other reflective surface. In further embodiments, as shown, the reflective surfaces may be flat, although curved (e.g., concave, convex) surfaces can be provided in further embodiments.

In embodiments, the method can include the step of exposing the separation path 151 on the glass ribbon 103 (or the glass sheet 104) by rotating the first reflector in a clockwise or counterclockwise rotation. For instance, as shown in FIGS. 8 and 9, the polygonal reflector 215 can rotate in the counterclockwise direction 217 about a first rotation axis 218 to sequentially position each of the eight reflective surface segments 219a-h within the selected path of the laser beam 203. The illustrated rotation shown in FIG. 8 depicts the principle of sweeping the laser beam spot 209. The actual configuration and/or rotation of the polygonal reflector 215 will depend on a wide range of factors, such as whether the laser beam spot 209 sweeps between extreme positions from the first outer edge 153 to the second outer edge 155 of the glass ribbon (e.g., between first and second outer positions 405, 407) or whether the laser beam spot 209 sweeps off the glass ribbon (e.g., between outer positions 501, 503) as shown in FIG. 2. The embodiment of FIGS. 8 and 9 illustrate the laser beam spot 209 sweeping between extreme positions from the first outer edge 153 to the second outer edge 155. Any embodiment of the disclosure, such as the embodiments of FIGS. 8 and 9 can also include the laser beam spot 209 sweeping off the glass ribbon 103 as shown in FIG. 2.

Further aspects of the step of exposing the separation path 151 on the glass ribbon 103 to rapidly heat the glass ribbon 103 along the separation path 151 with the exemplary polygonal reflector 215 will now be described. As shown in FIGS. 2 and 8, for example, as the first reflective surface segment 219a crosses the path of the laser beam 203, a first edge portion 221a of the first reflective surface segment 219a initially crosses the path of the laser beam 203 to reflect and expose an upstream end 221 of the separation path 151 across the glass ribbon 103 to the laser beam spot 209. As shown in FIG. 8, the upstream end 221 of the separation path 151 is exposed to the laser beam spot 209, thereby rapidly heating the separation path 151 at that location. As the polygonal reflector 215 rotates in the counterclockwise direction 217 about the first rotation axis 218, the angle of the first reflective surface segment 219a changes, such that the laser beam spot 209 travels along a direction 225 extending from the first outer edge portion 211a toward the second outer edge portion 211b of the glass ribbon 103.

The polygonal reflector 215 can be further rotated such that an intermediate portion 221b of the first reflective surface segment 219a subsequently crosses the path of the laser beam 203 to reflect and expose an intermediate location (301 in FIG. 2) of the separation path 151 to the laser beam spot 209, thereby heating the separation path at that location. The polygonal reflector 215 can be even further rotated in the counterclockwise direction 217 about the first rotation axis 218 such that a second edge portion 221c of the first reflective surface segment 219a subsequently crosses the path of the laser beam to reflect and expose a downstream end (401 in FIG. 2) of the separation path 151 to the laser beam spot 209, thereby heating the separation path at that location.

A further incremental rotation of the polygonal reflector 215 in the counterclockwise direction 217 about the first rotation axis 218 (e.g., from the position in which the second edge portion 221c crosses the path of the laser beam shown) will cause a first edge portion 403 of the second reflective surface segment 219b to cross the path of the laser beam 203, wherein the laser beam spot 209 will disappear from the downstream end 401 of the separation path 151 and reappear at the upstream end 221 of the separation path 151 as shown in FIG. 8. Of course, as the actual laser beam comprises a finite diameter, there is a short moment in time where the laser beam will simultaneously reflect from adjacent portions of adjacent reflective surface segments. At such a moment in time, the laser beam spot 209 can partially appear simultaneously at the outer extremes of the sweep path.

As such, the step of rapidly heating the glass ribbon along the separation path 151 with the exemplary polygonal reflector 215 can include repeatedly passing the laser beam spot 209 along the separation path 151 to heat the glass ribbon from the baseline temperature T1 to the melting temperature T2 of the glass composition of the glass ribbon. Moreover, in the illustrated embodiment, the step of repeatedly passing the laser beam spot 209 along the separation path 151 can optionally include repeatedly passing the laser beam spot 209 in the single direction 225. Indeed, as each of the reflective surface segments 219a-h crosses the path of the laser while the polygonal reflector 215 rotates in the illustrated counterclockwise direction 217 about the first rotation axis 218, the laser beam spot 209 always moves in the single direction 225 from the upstream end 221 to the downstream end 401 of the separation path 151.

The laser beam spot 209 can travel at various speeds along the single direction 225 depending on the rotational speed of the polygonal reflector 215. For example, the laser beam spot can travel along separation path 151 from about 0.5 km/s to about 6 km/s, such as from about 1 km/s to about 5 km/s, such as from about 2 km/s to about 4 km/s such as about 3 km/s.

Although not shown, in further embodiments, the separation path 151 can be rapidly heated in a wide variety of ways. For instance, multiple laser beam generators 201 can be provided and/or the laser beam produced by the laser beam generator can be split into two or more laser beams to simultaneously reflect laser beams from different mirrors and/or different portions of the same mirror of the polygonal reflector. As such, multiple laser beam spots can be provided that travel simultaneously along the separation path 151 in the single direction 225 or along opposite directions depending on the optical configuration of the glass separation apparatus 149.

In embodiments, the laser beam 203 produced by the laser beam generator 201 can be extended into an elongated laser beam spot that simultaneously heats the entire separation path 151. In such embodiments, the laser beam spot 209 can remain stationary while simultaneously heating the entire separation path 151. In still further examples, a plurality of stationary laser beam spots can be provided to heat the entire separation path 151. For instance, the stationary laser beam spots can be positioned end to end wherein the overall length of all of the laser beam spots extends along the entire length of the separation path 151, or greater than the entire length of the separation path 151. In further embodiments, the stationary laser beam spots can be positioned to partially overlap one another wherein the overall length of all of the laser beam spots also extends along the entire or greater than the entire length of the separation path 151.

In still further embodiments (not shown), a plurality of the glass separation apparatus 149 can be provided that each exposes a segment of the overall separation path to the laser beam spot 209. For instance, a plurality of glass separation apparatus 149 can be provided that can optionally be similar or identical to the previously-described glass separation apparatus 149. In embodiments, any number of glass separation apparatus (e.g., from 1, 2, 3 to greater than 5 glass separation apparatus) can be used in embodiments of the claimed subject matter. Each glass separation apparatus 149 can produce a laser beam that can rapidly heat the glass ribbon along a corresponding heated segment along the overall separation path with a respective laser beam spot 209 provided by each laser beam. In embodiments, the heated segments can be positioned end-to-end to heat the separation path.

Alternatively, each heated segment can overlap at least one adjacent heated segment at overlapping regions to provide sufficient heating of the separation path between the segments. In some embodiments, the overlapping regions can include an overlapped length that is from about 5% to about 40% of the length of at least one of the heated segments, such as from about 10% to about 30%, such as about 10% to about 25% of the length of at least one of the heated segments. In embodiments, each corresponding heated segment can have a length of about 800 millimeters (mm) with each overlapping region having an overlapped length of about 100 mm. Providing the segments and optional overlapping regions can help achieve a sufficient level of rapid heating along the overall separation path extending along the glass ribbon.

FIGS. 2 and 8 demonstrate an embodiment wherein the laser beam 203 (and the corresponding laser beam spot 209) sweeps between the first outer position 405 and the second outer position 407 (FIG. 2). In any of the embodiments of the disclosure, the laser beam 203 can travel off the glass ribbon during the step of heating the separation path 151. For instance, as shown in FIG. 2, the sweep of the laser beam 203 can optionally extend between outer positions 501, 503 that are outside the first and second outer edges 153, 155. Likewise, although not shown, the sweep of the laser beam of FIG. 9 can also travel off the glass ribbon during the step of rapidly heating the glass ribbon 103 along the separation path 151. Allowing the laser beam to sweep off the glass ribbon during heating can ensure that all portions of the separation path 151 achieve a sufficient level of laser energy to rapidly heat the glass ribbon to the melting temperature T2.

As further illustrated in FIG. 2, while exposing the separation path 151 on the glass ribbon 103, the glass ribbon 103 can be positioned such that the entire separation path 151 is located within the depth of focus DOF of the laser beam 203. The depth of focus DOF can be calculated by the formula:

$$DOF = ( \frac{8 λ}{π} ) {( \frac{F}{D} )}^{2}$$

where F is the focal length of the lens 207, D is the beam diameter before the lens, and λ is the wavelength.

Positioning the entire length of the separation path 151 within the depth of focus of the laser beam 203 can help increase efficiency of energy transfer from the laser beam to the separation path 151. Since the depth of focus of the laser beam exceeds amplitudes of the glass warp, thickness variation, and motion of the glass ribbon during separation, the depth of focus enables separation of non-flat glass with variable thickness, which can also move or to some extent change orientation relative to the laser beam generator 201. In embodiments, the depth of focus DOF can be from about 20 mm to about 400 mm, such as from about 20 mm to about 200 mm although other depths of focus can be provided in further embodiments.

Furthermore, in embodiments, the entire glass ribbon, in addition to the path of the glass ribbon, can be positioned within the depth of focus. The depth of focus of the laser beam can be large enough to exceed variations of the glass thickness, glass warp, or other possible changes in the position of the glass ribbon, and consequently the separation path on the glass ribbon, relative to the laser beam generator during the method of the present disclosure.

Furthermore, in embodiments, a dimension of the laser beam spot 209 on a major surface of the glass ribbon varies while repeatedly passing the laser beam spot along the separation path 151, especially near the ends of the separation path. For example, as shown in FIG. 2, the dimension of the laser beam spot 209 on the major surface of the glass ribbon can vary along the separation path 151 when the laser beam 203 is focused along sweep path 507 or sweep path 509, although other sweep paths can be provided while the glass ribbon is still maintained within the depth of focus.

As shown in FIG. 3, the laser beam spot 209 if traveling along sweep path 509 can apply a varying power density along the separation path 151, as represented by the illustrated truncated elliptical power density area 601, due to the changes in the diameter and shape of the laser beam spot 209 along the separation path 151. The elliptical power density area 601 of the laser beam spot 209 on the surface of the glass ribbon is truncated since the laser beam spot intentionally travels off the glass ribbon in the embodiment shown in FIG. 3. In further embodiments, a non-truncated elliptical power density area may be provided. For instance, the end points of the elliptical power density area can be located at the respective first and second outer edges 153, 155 of the glass ribbon 103.

When the outer edge portions 211a, 211b comprise thickened edge beads, it can be advantageous to separate the glass ribbon using two laser beams 203 that produce maximum power densities located near or at the thickened edges (e.g., edge beads), with portions of the respective laser beam spots overlapping in the central area of the glass ribbon. As the maximum power densities are located closer or at the thickened edges, more heat can be generated where there is more material, thereby balancing the through thickness heating when the thickness of the glass ribbon is not uniform. At the same time, partially overlapping the relatively lower power density provided by the tails of the laser beam spots can provide enhanced heating due to double exposure from the overlapping laser beam spots.

Referring again to the exemplary method for separating the glass ribbon 103 and simultaneously shape-forming separated edges thereof, the method further comprises, in a step (c), moving the laser beam spot 209 at a laser beam spot velocity including a laser beam spot velocity vector in the conveyance direction 901 that is equal to the glass ribbon velocity vector. During the steps (b) and (c), the separation path 151 continues to be exposed to the laser beam spot 209 to continue rapidly heating the glass ribbon along the separation path 151 while the glass ribbon 103 moves at the glass ribbon velocity. During the steps (b) and (c), the glass ribbon is rapidly heated from the baseline temperature T1 to the melting temperature T2 of the glass of the glass ribbon.

As described above, the baseline temperature T1 is within the annealing range of the glass of the glass ribbon 103. The melting temperature T2 represents a range of temperatures over which the glass (e.g., the glass material of the glass ribbon 103 proximate the separation path 151) transitions from a solid-like state to a molten, liquid state suitable for forming and processing. In embodiments, the melting temperature corresponds to a viscosity of from about 1×10² P to about 1×10³ P, depending on the specific glass composition. The melting temperature is described as a range of values rather than a fixed point. This convention is due to the nature of glass as an amorphous (non-crystalline) solid, which does not have a sharp melting point like crystalline materials. Instead, glass transitions gradually from a rigid state to a more fluid state over a range of temperatures.

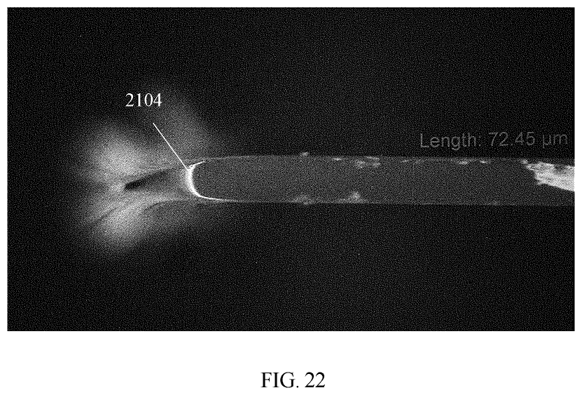

The method further comprises, in a step (d), melting the glass ribbon 103 along the separation path 151 while the separation path 151 is rapidly heated during steps (b) and (c). In response to the melting, a glass ribbon portion (e.g., the glass sheet 104) is separated from the glass ribbon 103 along the separation path 151 and rounded, separated edges (2104 in FIGS. 21 and 22) are simultaneously formed adjacent the separation path 151 on both the glass ribbon portion 104 and the glass ribbon 103. The rounded, separated edges 2104 formed on both the glass ribbon portion 104 and the glass ribbon 103 are described in more detail later in this disclosure in connection with the Examples.

The method will now be described with reference to FIGS. 4-9. These figures depict various implementations of the glass separation apparatus 149 that can be used to carry out aspects of steps (c) and (d) of the method disclosed herein. As noted above, FIGS. 4-7 schematically depict general implementations of the glass separation apparatus whereas FIGS. 8 and 9 schematically depict a specific implementation of the glass separation apparatus. In the following description of the method, it should be appreciated that any implementation disclosed hereinafter is intended to be exemplary and therefore non-limiting.

FIGS. 4-9 demonstrate exemplary apparatus and methods that can separate the glass ribbon 103 while the glass ribbon moves along a direction of the length of the glass ribbon (e.g., the conveyance direction 901). Unless otherwise noted, aspects of the disclosure discussed above and with reference to FIGS. 1-3 can apply to the exemplary apparatus and methods of FIGS. 4-9.

The glass separation apparatus 149, 849 includes at least one laser, such as the laser beam generator 201 that produces the laser beam 203 as discussed more fully above. As shown in the embodiment of FIGS. 8 and 9, the glass separation apparatus 149, 849 further includes a first reflector, such as the polygonal reflector 215 discussed above. The polygonal reflector 215 can include the previously-discussed first reflective surface. The first reflective surface is rotatable (e.g., in the counterclockwise direction 217) about a first rotation axis 218. In embodiments, the first reflective surface 219 of the polygonal reflector 215 can comprise a plurality of reflective surface segments similar or identical to the previously-discussed eight reflective surface segments 219a-h. The plurality of reflective surface segments can be rotated (e.g., in the counterclockwise direction 217) about the first rotation axis 218 to reflect the laser beam 203 from the reflective surface segments to cause the resultant laser beam spot 209 to repeatedly pass along the separation path 151 on the glass ribbon 103 in a direction (e.g., 225 in FIGS. 8 and 9) transverse to the conveyance direction 901 such as a direction of the width W of the glass ribbon to rapidly heat the glass ribbon 103 along the separation path 151.

In embodiments, the glass separation apparatus 149, 849 comprises or cooperates with a tracking feature that enables the glass separation apparatus to separate the glass ribbon 103 while the glass ribbon is moving (e.g., moving in the conveyance direction 901). As shown in the embodiment of FIGS. 8 and 9, the tracking feature comprises a second reflector 205d including a respective second reflective surface 206 that can be rotatable about a corresponding second rotation axis 227 along direction 903 to reflect the laser beam 203 to cause the laser beam spot 209 to move in the conveyance direction 901. In the embodiment of FIGS. 4-7, the tracking feature can the same as or similar to the tracking feature (e.g., the second reflector 205d) described with reference to FIGS. 8 and 9, or the tracking feature can be different yet still enable the laser beam spot 209 to move in the conveyance direction 901 as shown in FIGS. 4-7.

In embodiments, the method comprises moving the laser beam spot 209 at the laser beam spot velocity including the laser beam spot velocity vector in the conveyance direction 901 that is equal to the glass ribbon velocity vector in the conveyance direction 901. As such, the laser beam spot 209 remains on the same separation path 151 to continuously expose the separation path 151 on the glass ribbon 103 and, consequently, continuously rapidly heat the glass ribbon 103 along the separation path 151 even though the glass ribbon 103 is moving in the conveyance direction 901 (e.g., draw direction). In a down-draw process, the laser beam spot 209 can include a velocity vector in the draw direction 901 that is equal or substantially equal to the velocity of the glass ribbon in the draw direction 901. As such, the laser beam spot 209 remains on the same separation path 151 of the glass ribbon 103 to continuously expose the separation path on the glass ribbon and, consequently, continuously rapidly heat the glass ribbon along the separation path 151 even though the glass ribbon is moving in the draw direction of the glass ribbon 103.

As shown in FIGS. 8 and 9, the first rotation axis 218 can be perpendicular to the second rotation axis 227 although the first axis and second axis can be orientated at another angle relative to one another depending on the optical configuration and/or the desired properties of the laser beam spot 209. In embodiments, the first reflector can be positioned upstream or downstream relative to the second reflector. For example, the glass separation apparatus 849 of FIGS. 8 and 9 illustrate an embodiment in which the second reflector 205d is positioned upstream of the first reflector 215 such that the laser beam 203 reflects off the second reflective surface 206 of the second reflector 205d prior to reflecting off the first reflective surface 219 of the first reflector 215. In embodiments, the glass separation apparatus can allow selection to avoid rotating of the second reflective surface 206. Avoiding rotation of the second reflective surface 206 can be desirable in applications where the glass ribbon is not moving along the length of the glass ribbon.

In embodiments, the second reflector 205d can be provided without the first reflector 215. In such embodiments, the at least one laser beam generator can be configured to produce a single laser beam spot extending along the entire width of the glass ribbon or greater than the entire width of the glass ribbon. Alternatively, the at least one laser beam generator may produce a plurality of laser beam spots (e.g., that may optionally partially overlap one another) that together extend along the entire width of the glass ribbon or greater than the entire width of the glass ribbon. In such embodiments, a single laser beam spot traveling along the separation path is not needed since a stationary single elongated laser beam spot or a plurality of stationary laser beam spots span across the entire width of the separation path. In such embodiments, the second reflector 205d can be provided to allow the single laser beam spot or plurality of laser beam spots to move together with the glass ribbon along conveyance direction 901 (e.g., draw direction) of the glass ribbon to continuously heat the separation path 151 even though the glass ribbon is moving along the conveyance direction 901.

As illustrated in the embodiments of FIGS. 4-7 and 9, the method can include reflecting the at least one laser beam 203 off the rotating reflective surface 206 to cause the laser beam to move in the conveyance direction 901 (e.g., draw direction) such that the laser beam travels together with the glass ribbon. In such a way, each embodiment of FIG. produces thermal stress along the separation path 151 even while the separation path 151 is moving in the direction 901.

By way of illustration, embodiments of rapidly heating the glass ribbon 103 along the separation path 151 using the apparatus illustrated in FIGS. 4-7 and 9 will be discussed. Referring initially to FIGS. 4 and 9, a laser beam 203 produced by the laser beam generator 201 can pass through one or more optical lenses 207 to produce a laser beam spot 209 with a desired shape. The laser beam 203 then reflects off the second reflective surface 206 (e.g., before the first reflective surface 219) at a first rotational position relative to the second rotation axis 227. While in the first rotational position shown in FIG. 9, the second reflective surface 206 reflects the laser beam 203 to intersect the first reflective surface 219 at a first location 905a. The laser beam then reflects off the first reflective surface 219 from the first location 905a to intersect the separation path 151 with the glass ribbon 103 at a first position P1 and at a lateral location (e.g., in the direction of the width W of the glass ribbon) on the separation path dependent upon the rotational position of the first reflector 215 relative to the first rotation axis 218 as discussed above. Indeed, when using the illustrated polygonal reflector as the first reflector 215, rotation of the polygonal reflector about the first rotation axis 218 in the counterclockwise direction 217 will cause the laser beam spot to travel along the separation path 151 in direction 225 from the first outer edge portion 211a toward a second outer edge portion 211b of the glass ribbon 103. As further discussed above, the step of repeatedly passing the laser beam spot can optionally include repeatedly passing the laser beam spot in a single direction (e.g., the direction 225).

The second reflective surface 206 can be rotated (e.g., continuously rotated) at a rotational rate (e.g., a constant rotational rate) about the second rotation axis 227 such that the location of reflection off of the first reflective surface 219 travels in a direction 907, such as the illustrated direction, which is parallel to the first rotation axis 218. Moving the location of reflection in the direction 907 causes the laser beam spot 209 follow the glass ribbon in the conveyance direction 901 to allow the laser beam spot to continuously intersect with the separation path 151 while the separation path moves in the conveyance direction 901 and the direction 225 transverse (e.g., perpendicular) to the conveyance direction 901.

The second reflective surface 206 can be rotated from the first rotational position (shown in FIG. 9) about the second rotation axis 227 in direction 903 to a second rotational position (not shown). While in the second rotational position, the second reflective surface 206 reflects the laser beam 203 to intersect the first reflective surface 219 at a second location downstream from the first location 905a in the direction 907 (FIG. 9). The laser beam then reflects off the first reflective surface 219 from the second location to intersect the laser beam spot 209 with the separation path 151 that has moved downstream in the conveyance direction 901 to the second position P2 shown in FIG. 5 compared to the first position P1 of the separation path 151 shown in FIGS. 4 and 9.

The second reflective surface 206 can be still further rotated from the second rotational position (not shown) about the second rotation axis 227 in direction 903 to a third rotational position (not shown). While in the third rotational position, the second reflective surface 206 reflects the laser beam 203 to intersect the first reflective surface 219 at a third location downstream from the second location in the direction 907. The laser beam then reflects off the first reflective surface 219 from the third location to intersect the laser beam spot 209 with the separation path 151 that has moved downstream in conveyance direction 901 to the third position P3 shown in FIG. 6 compared to the second position of the separation path 151 shown in FIG. 5.

As can be appreciated, the second reflective surface 206 is described above using incremental movements and FIGS. 4-9 show incremental positions of the separation path 151, the movement of the second reflective surface 206 can be rotated continuously about the second rotation axis 227 to cause the laser beam spot 209 to continuously intersect with the separation path 151 as the separation path moves in the direction of the length of the glass ribbon (e.g., the conveyance direction.

In any of the embodiments of the disclosure, rotation of the second reflective surface 206 can be coordinated with the velocity of the glass ribbon in the conveyance direction 901 (e.g., in the draw direction) such that the laser beam spot continuously intersects the separation path 151 as the separation path moves along the conveyance direction 901. For example, the second reflective surface 206 can be manually rotated about the second rotational axis 227. In further embodiments, an actuator (not shown) can be used to rotate the second reflective surface 206 at a continuous predetermined rotational speed to cause the laser beam spot to continuously intersect the separation path 151 as it moves in the direction of the length and as the laser beam spot moves along the direction 225.

In still further embodiments, the actuator can optionally be operated by a controller configured to obtain feedback from a sensor that senses the velocity of the glass ribbon in the direction of the length of the glass ribbon (e.g., down draw direction 901) and enters the velocity of the glass ribbon in an algorithm that calculates a target rotational rate of the second reflective surface 206 about the second rotation axis 227. The controller can then operate the actuator to rotate the second reflective surface 206 at the target rotational rate to cause the laser beam spot to continuously intersect the separation path 151.

In still further embodiments, sensors (e.g., thermal or optical sensors) can be employed to determine where the laser beam spot is intersecting the corresponding major surface of the glass ribbon. The controller can compare this location to the location of the separation path and operate the actuator to increase, decrease, or maintain the current rotational rate of the second reflective surface 206 about the second rotation axis 227 such that the laser beam spot continuously intersects the corresponding major surface of the glass ribbon.

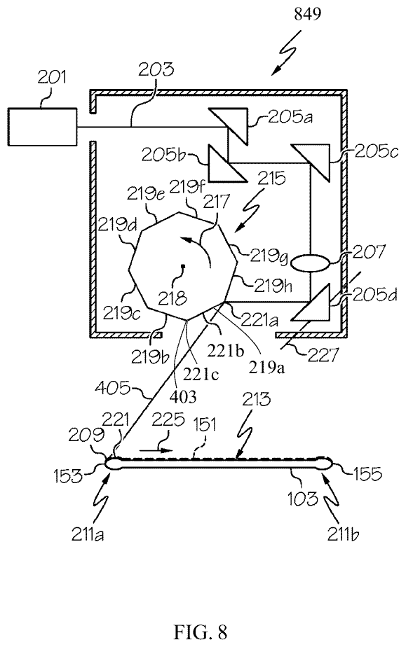

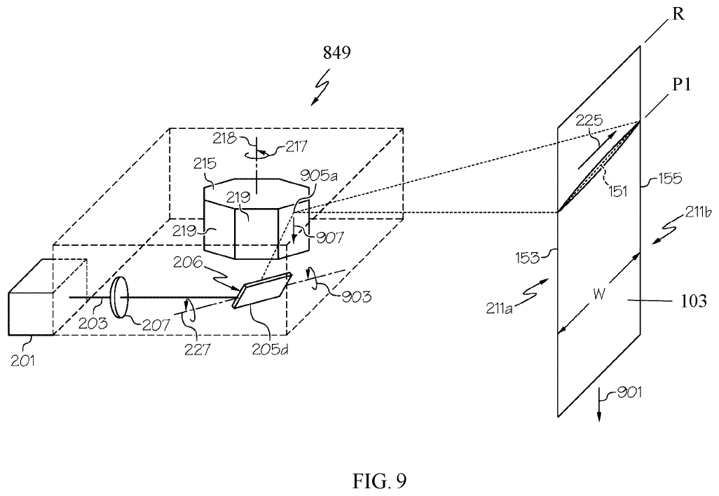

FIGS. 10 and 11 depict further implementations of the glass separation apparatus configured to cooperate with a tracking feature that enables the glass separation apparatus to separate the glass ribbon 103 while the glass ribbon is moving (e.g., moving in the conveyance direction 901). In FIGS. 10 and 11, the glass separation apparatus is identified with reference number 1049 to indicate differences with respect to the glass separation apparatus 149, 849 described with reference to FIGS. 8 and 9. In particular, the glass separation apparatus 1049 of FIGS. 10 and 11 do not comprise the second reflector 205d (e.g., the tracking feature). As such, the glass separation apparatus 1049 of FIGS. 10 and 11 do not have internal components that can cause the laser beam spot 209 to move in the conveyance direction 901 so as to track the movement of the glass ribbon 103.

As schematically illustrated in FIG. 10, in embodiments, the tracking feature can be an external tracking feature configured as a traveling anvil machine (TAM) 1004 to which the glass separation apparatus 1049 can be connected for conjoint movement therewith in a direction 1008 that is substantially parallel to the conveyance direction 901. TAM 1004 moves (e.g., continuously) with a velocity vector that is the same or substantially the same as glass ribbon velocity vector over a range, or stroke, from a top-most position to a bottom-most position. In embodiments, the top-most position is configured to position the glass separation apparatus 1049 such that the laser beam spot 209 exposes the separation path 151 on the glass ribbon 103 at the first position P1 as described above. The bottom-most position is configured to position the glass separation apparatus 1049 such that the laser beam spot 209 exposes the separation path 151 on the glass ribbon 103 at the third position P3, as described above, at which, in response to the melting (e.g., step (d) of the method) the glass ribbon portion (e.g., the glass sheet 104) is separated from the glass ribbon along the separation path and rounded, separated edges (2104 in FIGS. 21 and 22) are simultaneously formed adjacent the separation path on both the glass ribbon portion and the glass ribbon. TAM 1004 can have any number of infinite positions between the top-most position and the bottom-most position, such as the intermediate position configured to position the glass separation apparatus 1049 such that the laser beam spot 209 exposes the separation path 151 on the glass ribbon 103 at the second position P2, as described above

In embodiments, TAM 1004 moves downward with the glass ribbon in a reciprocating motion from a home position at the upper-most or top of the TAM stroke, to a lower-most position at the bottom of the TAM stroke. The lower-most position substantially coincides with the point at which a glass sheet is separated from the ribbon, upon the completion of which action the TAM returns to the home position so that the method can be repeated for separation of another glass sheet 104 from the glass ribbon 103.

As schematically illustrated in FIG. 11, in embodiments, the tracking feature can be an external tracking feature configured as an angle device 1104 to which the glass separation apparatus 1049 can be connected for conjoint movement therewith. In such embodiments, the angle device 1104 is configured to change an angular orientation of the glass separation apparatus 1049 relative the first major surface of the glass ribbon. As shown in FIG. 11, the angel device 1104 can be configured to rotate the glass separation apparatus 1049 about a rotational axis that approximately coincides with the point from which the laser beam is emitted from the glass separation apparatus 1049. Similar to the TAM 1004 of FIG. 10, the angle device 1104 can rotate the glass separation apparatus 1049 with an angular rate configured to move the separation path 151 exposed by the laser beam spot 209 with a velocity vector that is the same or substantially the same as glass ribbon velocity vector over a range, or stroke, from a starting angular position to an ending angular position. In embodiments, the starting angular position is configured to position the glass separation apparatus 1049 such that the laser beam spot 209 exposes the separation path 151 on the glass ribbon 103 at the first position P1 as described above. The ending angular position is configured to position the glass separation apparatus 1049 such that the laser beam spot 209 exposes the separation path 151 on the glass ribbon 103 at the third position P3, as described above, at which, in response to the melting (e.g., step (d) of the method) the glass ribbon portion (e.g., the glass sheet 104) is separated from the glass ribbon along the separation path and rounded, separated edges 2104 are simultaneously formed adjacent the separation path on both the glass ribbon portion and the glass ribbon. The angle device 1104 can have any number of infinite angular positions between the starting angular position and the ending angular position, such as the intermediate position configured to position the glass separation apparatus 1049 such that the laser beam spot 209 exposes the separation path 151 on the glass ribbon 103 at the second position P2, as described above

In embodiments, angle device 1104 rotates in a reciprocating motion from a home position at the first angular position to a fully-rotated position at the ending angular position. The fully-rotated position substantially coincides with the point at which a glass sheet is separated from the ribbon, upon the completion of which action the angle device 1104 returns to the home position so that the method can be repeated for separation of another glass sheet 104 from the glass ribbon 103.

Referring again to the exemplary method for separating the glass ribbon 103 and simultaneously shape-forming separated edges thereof, a duration from the exposing of step (c) to the melting of step (d) to the point at which the glass ribbon portion 104 is separated from the glass ribbon 103 along the separation path 151 is in a range of from about 0.2 s to about 10 s, such as from about 0.3 s to about 9 s, from about 0.4 s to about 8 s, from about 0.5 s to about 7 s, from about 0.6 s to about 6 s, from about 0.7 s to about 5 s, from about 1 s to about 5 s, from about 0.8 s to about 4 s, from about 0.9 s to about 3 s, from about 1 s to about 3 s, or from about 1 s to about 2 s, and also comprising all sub-ranges and sub-values between these range endpoints. In embodiments, the separation path 151 is configured to remain within the annealing zone from the exposing of step (c) to the melting of step (d) to the point at which the glass ribbon portion 104 is separated from the glass ribbon 103 along the separation path 151.

Any of the embodiments or implementations of apparatus or methods disclosed herein can facilitate separating of a wide range of glass ribbons that may be flat (as shown) or may have a non-flat (e.g., warped) configuration such as bowed into a C-shape, S-shape, or other configuration. Furthermore, any of the above embodiments or implementations can facilitate separation of glass ribbons with a substantially uniform thickness or a non-uniform variable thickness. For instance, a glass ribbon with relatively thick edge beads and a relatively thin central portion can be separated. In embodiments, the glass ribbon can have a thickness in a range of from about 50 μm to about 1000 μm, such as from about 100 μm to about 750 μm or from about 150 μm to about 500 μm. In connection with any of these thicknesses, the glass ribbon can have locally thicker portions (e.g., edges, beads) of up to about 1500 μm, such as up to 1000 μm or up to 750 μm.

In embodiments, the glass ribbon can be separated when the glass ribbon is relatively stationary or when the glass ribbon is in motion. For example, the glass ribbon can be separated while in motion as it is being drawn from a forming member or if the glass ribbon is slightly swinging and/or twisting relative to the forming member.

Furthermore, any of the above embodiments or implementations can be used to separate non-strengthened glass or strengthened glass. For instance, the apparatus and methods disclosed herein can be used to separate a strengthened glass ribbon (e.g., chemically strengthened glass ribbon) including at least one outer layer under compression and another layer in tension. In embodiments, the apparatus and methods disclosed herein can be used to separate strengthened glass ribbon that is strengthened on both sides, wherein the two major surfaces of the glass ribbon are in compression and the central portion of the glass ribbon is in tension.

In further embodiments, the apparatus and methods disclosed herein can be used to separate glass ribbon comprising laminated glass ribbon layers. In embodiments, the laminated structure can be provided with a compressive surface layer and a central layer under tension. In embodiments, the laminated structure can be provided with two compressive surface layers with a central layer under tension sandwiched between the two compressive layers. In still further embodiments, the apparatus and methods disclosed herein can be used to separate laminated glass ribbon layers where at least two of a plurality of layers includes different compositions and/or different coefficients of thermal expansion. In embodiments, the glass ribbon can be a chemically or thermally strengthened glass ribbon, wherein the glass ribbon comprises a surface compressive stress layer produced by ion exchange or thermal processing.

### Example

Various embodiments of the present disclosure can be better understood by reference to the following Example which are offered by way of illustration. The present disclosure is not limited to the Example given herein.

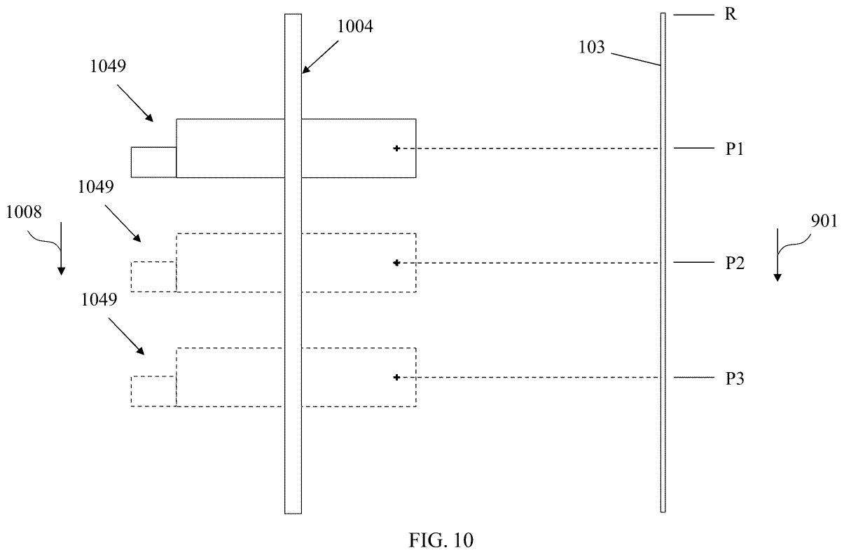

Glass ribbon separation trials were conducted to verify the principles and embodiments of the present disclosure. An important aspect of the methods disclosed herein is the background or baseline temperature of the glass ribbon during processing. The glass ribbon separation process disclosed herein is implemented on glass with a baseline temperature in the annealing range, which is significantly higher than that used in conventional glass ribbon separation techniques. FIG. 12 is a thermal image of a sample glass ribbon showing a temperature distribution of the sample glass ribbon in the annealing zone of a glass manufacturing apparatus. As shown in FIG. 12, the temperature gradually drops down starting from about 840° C.

An infra-red (IR) laser beam is formed by a beam delivery system into any one of the laser beam spot configurations disclosed hereinabove (e.g., small moving spot or large elongated stationary spot) to deliver laser radiation on a narrow line on the glass surface (e.g., the separation path 151) that has a length, which is equal or exceeds the width of the ribbon, and that tracks the movement of the glass ribbon motion. The laser parameters, such as laser power and exposure time, are set to enable quick temperature spike of heated line from about annealing temperature up to the melting point, which creates a narrow melting zone under the beam and induces ribbon separation accompanied by nearly round edge forming (e.g., primarily by surface tension) at the separated edges adjacent the narrow melting zone. Implementing the glass ribbon separation process disclosed herein with the baseline temperature of the glass ribbon within the annealing range minimizes residual stress, which can be caused by the laser heating.

Various compositions of glasses can have high absorption in the IR range of the spectrum, especially at longer wavelengths, such as longer than 5 μm to even higher at 9-11 μm. There are high power lasers with power level spreading from a few watts up to multiple kW working in this wavelength range, such as carbon monoxide (CO) and carbon dioxide (CO₂) lasers. Due to high absorption of the laser wavelength, the laser energy is first absorbed in the glass skin layer (e.g., withing the first 10-20 μm from the surface), and then the laser energy is transferred through the glass thickness due to thermal conductivity. An excessive laser energy can cause damage of the skin layer via ablation and evaporation of the glass. However, if the laser power at the glass surface is effectively managed by controlling laser parameters, such as the power level, the area through which the power is delivered, and the exposure time, then this balanced laser heating will enable uniform heating of the glass over the surface and through the thickness. Laser heating will lower the viscosity of the glass, allowing its shaping and, eventually, to melting so separate the glass ribbon and simultaneously shape-form separated edges thereof.

In addition to the high absorption of the IR laser radiation in the glass, the laser beam allows tight control over the area exposed to the laser radiation by using beam shaping optics. Beam shaping optics enable a variety of options for heating zones, such as elongated elliptical beams with different axis ratios. Besides, distribution of the power distribution within the cross-section of the beam can be varied among a Gaussian profile, a flat-top profile, or more complex distributions, such as when more than one beam is used in the process allowing superposition of the beams and leading to different heating patterns. Laser power for each beam can be independently controlled with high accuracy and repeatability. Moreover, the duration of the laser exposure can also be well controlled

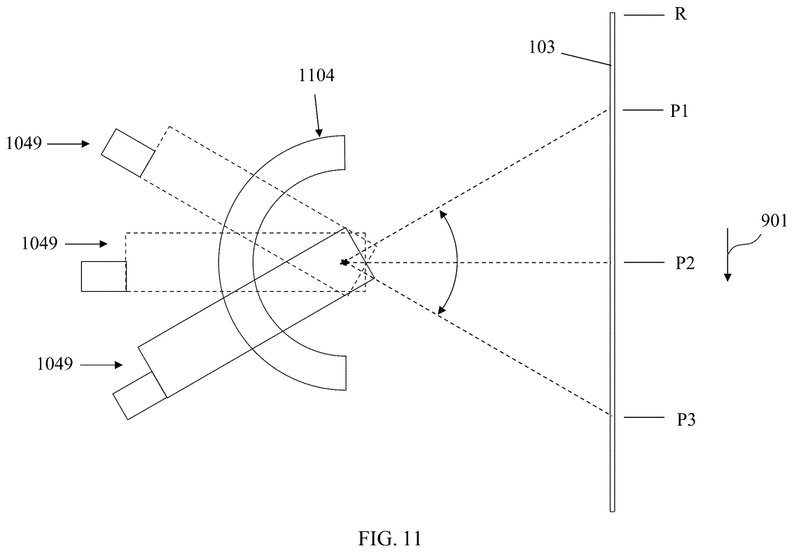

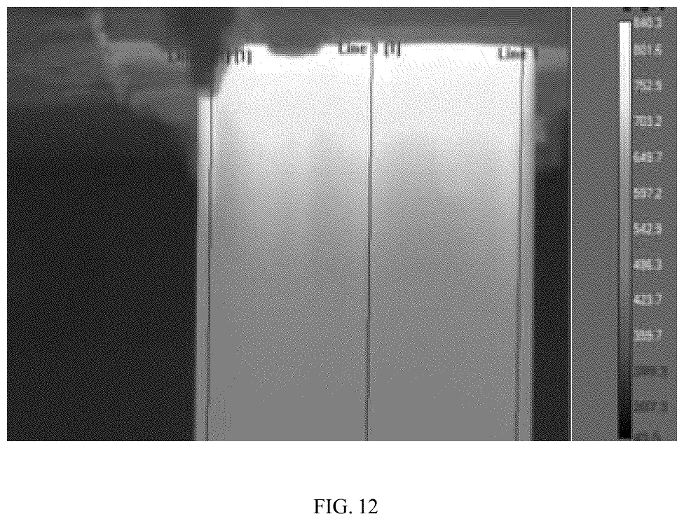

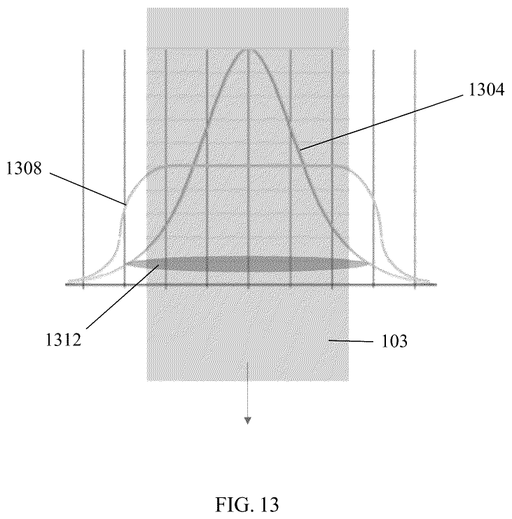

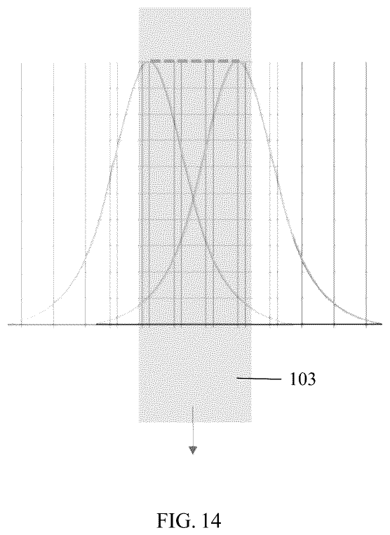

FIGS. 13-15 depict various beam shaping strategies that can be used in connection with the glass ribbon separation process disclosed herein. FIG. 13 shows the principle of glass ribbon cutting when a Gaussian profile 1304 or a flat-top beam profile 1308 is used to irradiate the glass ribbon. As shown in FIG. 13, the Gaussian profile 1304 results in a truncated elliptical power density area 1312 exposed on the surface of the glass ribbon 103. FIG. 14 shows superposition of two Gaussian beams to form a nearly flat-top profile in the central portion of the resultant beam. FIG. 15 shows superposition of two Gaussian beams to form a donut-shape beam. FIG. 16 is a thermal image of a sample glass ribbon laser-heated via a donut-shape beam profile similar to that depicted in FIG. 15. As shown in FIG. 16, the color intensities indicate higher intensity heating along the separation path 1604 near the lateral edges of the sample glass ribbon.

The choice of beam profile can be based on the glass thickness profile. In aspects, for example, a glass ribbon with uniform thickness may be better separated using a flat-top profile (1308 in FIG. 13). In aspects, a glass ribbon with thicker beads along the lateral edges may be better separated using a beam profile with higher intensity near the lateral edges, similar to a donut-shape beam profile (FIG. 15). However, it should be appreciated that virtually any beam profile can successfully separate a glass ribbon having any thickness profile.

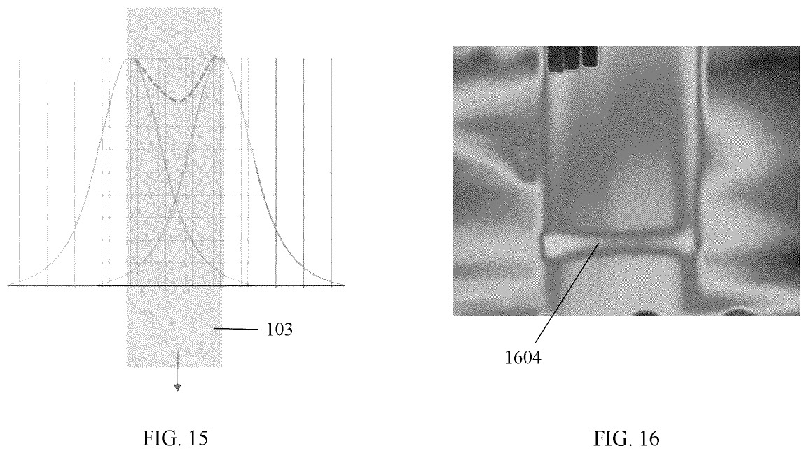

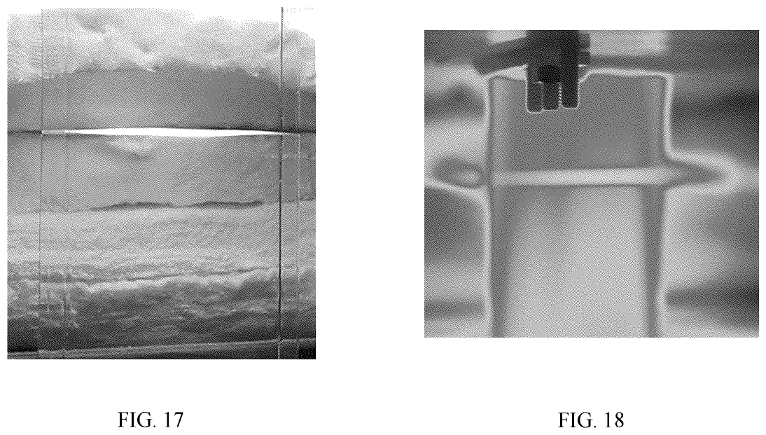

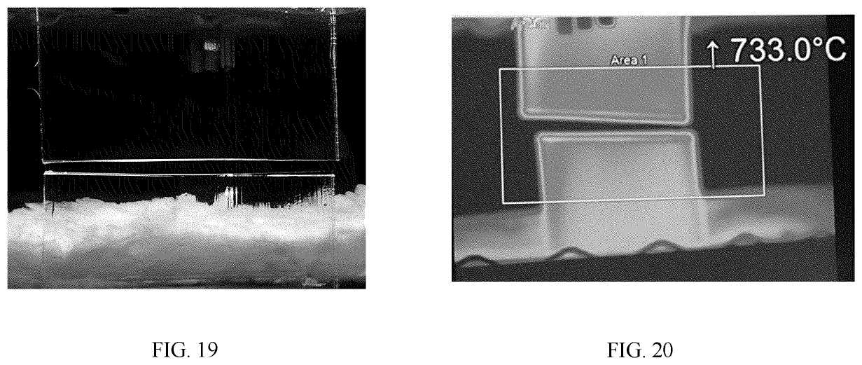

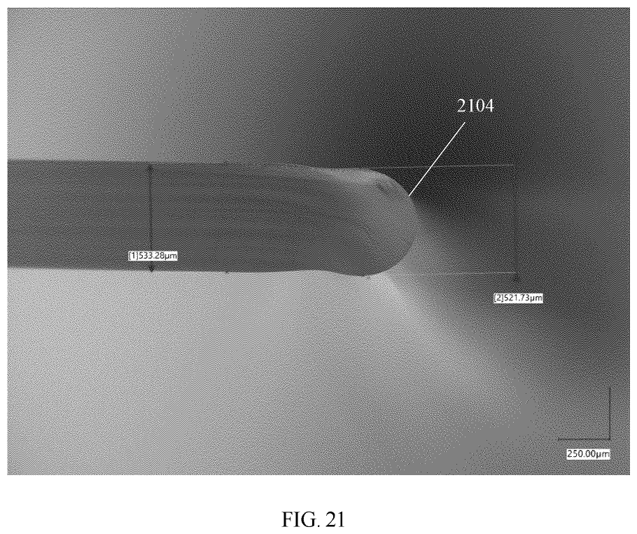

FIG. 17 illustrates laser heating of a sample glass ribbon by a single laser beam in the annealing zone. FIG. 18 is a thermal image of the sample glass ribbon of FIG. 17. FIG. 19 illustrates a sample glass ribbon at the moment of ribbon separation in the annealing zone. FIG. 20 is a thermal image of the sample glass ribbon of FIG. 19. The sample glass ribbons described herein were separated using a system that comprise a CO₂ laser (400 W), beam delivery system, and optical head with beam shaping lenses. The optical head was configured as a flying optical head, which tracks the motion of the glass ribbon being drawn and provides access of the laser beam to the glass ribbon in the annealing zone of the glass manufacturing apparatus.

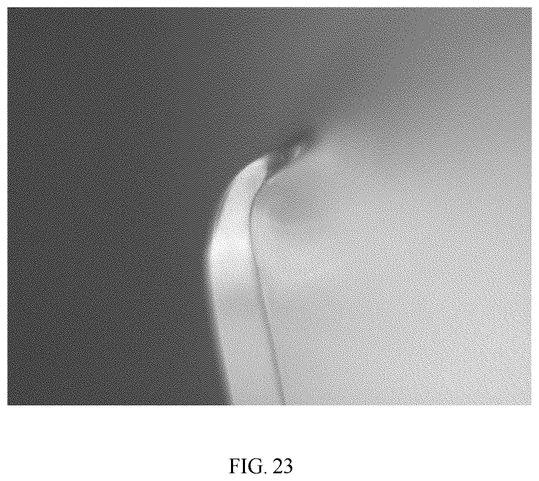

FIGS. 21 and 22 show examples of the shape of the separated edges 2104 after separation from sample glass ribbons of different thicknesses. FIG. 21 shows the shape of the separated edge 2104 from a sample glass ribbon with a thickness of about 500 μm. FIG. 22 shows the shape of the separated edge 2104 from a sample glass ribbon with a thickness of about 75 μm. In embodiments, a typical shape of the separated edge can be approximated by a sphere having radius equal to about half of glass thickness. The shape of the separated edge is defined by gravity and surface tension of the glass. FIG. 23 show an example of the shape of the rounded corner that is formed at the intersection of the separated edge and the lateral edge of a sample glass ribbon with a thickness of about 75 μm. As shown in FIG. 23, the rounded corner has a radius of about 200 μm.

Embodiments of the apparatus and methods disclosed herein have numerous advantages. The methods disclosed herein enable forming of a rounded, separated glass edge (e.g., which does not require finishing) along the separation. The methods disclosed herein combine separation (cutting) process of the glass ribbon (simultaneously) with edge forming at the draw. The methods disclosed herein avoid high local laser-induced residual stresses in glass without annealing—a typical problem accompanying many processes that include glass heating above strain point. The round shape edge formed by the methods disclosed herein can function as a temporary edge for customer applications such that manufacturing cost associated with edge finishing can be reduced or even eliminated. Unlike mechanical scribing, the methods disclosed herein do not generate glass chips (e.g., particles), thereby promoting cleaner manufacturing conditions and clean sheet production at the bottom of the draw (BOD). The methods disclosed herein are scalable for larger glass ribbon sizes.

While the disclosure has been illustrated and described in detail in the drawings and foregoing description, the same should be considered as illustrative and not restrictive in character. It is understood that only the preferred embodiments have been presented and that all changes, modifications, and further applications that come within the spirit of the disclosure are desired to be protected.

What is claimed is:

1. A method for separating a glass ribbon, comprising:
moving the glass ribbon at a glass ribbon velocity including a glass ribbon velocity vector in a conveyance direction of the moving glass ribbon;
exposing a separation path on the glass ribbon to at least one laser beam spot to rapidly heat the glass ribbon along the separation path, the separation path extending in a direction transverse to the conveyance direction to opposed lateral edges of the glass ribbon;
moving the laser beam spot at a laser beam spot velocity including a laser beam spot velocity vector in the conveyance direction that is equal to the glass ribbon velocity vector, wherein the separation path continues to be exposed to the laser beam spot to continue rapidly heating the glass ribbon along the separation path while the glass ribbon moves at the glass ribbon velocity; and
melting the glass ribbon along the separation path while the separation path is rapidly heated during steps (b) and (c), wherein, in response to the melting, a glass ribbon portion is separated from the glass ribbon along the separation path and rounded, separated edges are simultaneously formed adjacent the separation path on both the glass ribbon portion and the glass ribbon.

2. The method of claim 1, wherein step (b) comprises positioning the separation path within an annealing zone of the glass ribbon along which a first temperature of the glass ribbon is within an annealing range of a glass composition of the glass ribbon.

3. The method of claim 2, wherein during steps (b) and (c), the glass ribbon is rapidly heated from the first temperature to a second temperature that corresponds to a melting temperature of the glass composition of the glass ribbon.

4. The method of claim 1, wherein a duration from the exposing of step (c) to the melting of step (d) is in a range of from about 0.2 s to about 10 s.

5. The method of claim 1, wherein the separation path is configured to remain within the annealing zone from the exposing of step (c) to the melting of step (d).

6. The method of claim 1, wherein a wavelength of the at least one laser beam spot is within the infrared portion of the electromagnetic spectrum.

7. The method of claim 6, wherein the wavelength of the at least one laser beam spot is in a range of from about 2 μm to about 20 μm.

8. The method of claim 1, wherein the at least one laser beam spot has a beam profile selected based on a thickness profile of the glass ribbon along the separation path.

9. The method of claim 8, wherein the beam profile is selected to uniformly heat the glass ribbon along the separation path.

10. The method of claim 8, wherein the beam profile comprises at least one of a Gaussian beam profile, a flat-top beam profile, or a donut-shape beam profile.

11. The method of claim 8, wherein the at least one laser beam spot of step (b) comprises exactly one elongated laser beam spot that rapidly heats the glass ribbon along an entire length of the separation path during steps (b) and (c).

12. The method of claim 8, wherein a flat-top beam profile is selected when the glass ribbon has a uniform thickness in the direction transverse to the conveyance direction.

13. The method of claim 8, wherein the at least one laser beam spot of step (b) comprises a plurality of laser beam spots that each rapidly heat the glass ribbon along a corresponding segment of the separation path during steps (b) and (c).

14. The method of claim 13, wherein each segment of the separation path overlaps a portion of at least one adjacent segment of the separation path.

15. The method of claim 14, wherein a donut-shape beam profile is selected when the glass ribbon has thicker beads proximate lateral edges of the glass ribbon.

16. The method of claim 1, wherein step (c) includes reflecting at least one laser beam off a rotating reflective surface to cause the laser beam spot to move at the laser beam spot velocity vector.

17. The method of claim 1, further including repeatedly passing the laser beam spot along the separation path in the direction transverse to the conveyance direction to rapidly heat the glass ribbon along the separation path during steps (b) and (c).

18. The method of claim 17, wherein the laser beam spot velocity of step (c) includes another laser beam spot velocity vector in the direction transverse to the conveyance direction, wherein the laser beam spot moves in the conveyance direction and the direction transverse to the conveyance direction such that the separation path continues to be exposed to the laser beam spot to rapidly heat the glass ribbon along the separation path while the glass ribbon moves at the glass ribbon velocity and while the laser beam spot continues to repeatedly pass along the separation path in the direction transverse to the conveyance direction.

19. The method of claim 18, wherein step (c) comprises:
reflecting at least one laser beam off a first reflective surface rotating about a first axis to cause the laser beam spot to repeatedly pass along the separation path in the direction transverse to the conveyance direction and reflecting the at least one laser beam off a second reflective surface rotating about a second axis to cause the laser beam spot to move at the laser beam velocity vector in the conveyance direction of the glass ribbon.

20. The method of claim 19, wherein the at least one laser beam reflects off the first reflective surface before the second reflective surface.

21. The method of claim 19, wherein the first axis is perpendicular to the second axis.

22. The method of claim 17, wherein the step of repeatedly passing the beam spot includes repeatedly passing the beam spot in a single direction transverse to the conveyance direction.

23. The method of claim 1, wherein the glass ribbon includes a length and a width extending between a first edge and a second edge of the glass ribbon, and the conveyance direction is a direction of the length of the glass ribbon.

24. The method of claim 1, wherein the glass ribbon is drawn from a forming body, and the conveyance direction is a draw direction of the glass ribbon.
